(19) United States
(12) Patent Application Publication
(10) Pub. No.: US 2007/0078547 A1
(43) Pub. Date: Apr. 5, 2007

(54) SOUND OUTPUT SYSTEM AND METHOD

(75) Inventors: Kuan-Hong Hsieh, Shenzhen (CN); Han-Che Wang, Shenzhen (CN); Shin-Hong Chung, Shenzhen (CN); Wen-Chuan Lian, Shenzhen (CN); Xiao-Guang Li, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,446

(22) Filed: Aug. 8, 2006

(30) Foreign Application Priority Data
Sep. 9, 2005 (TW) 094130999

(51) Int. Cl. G06F 17/00

(52) U.S. Cl. 700/94

(57) ABSTRACT

A sound output apparatus is provided. The sound output apparatus includes a memory for storing compensation parameters; a Universal Serial Bus (USB) interface for connecting an external audio signal generating device thereto; a USB controller for reading the compensation parameters from the memory to the audio signal generating device when the audio signal generating device is connected thereto; and an analog interface for receiving regulated audio signals from the audio signal generating device according to the compensation parameters.

### CROSS-REFERENCES TO RELATED APPLICATION

This application is incorporated with U.S. patent application Ser. No. 11/173130 entitled “sound outputting apparatus having compensation characteristics,” filed on Jul. 1, 2005 herein by reference.

### TECHNICAL FIELD

The present invention relates to sound output systems and methods, and particularly to a sound output system and method having compensation characteristics.

### GENERAL BACKGROUND

Today, we often listen to a portable device, such as an audio signal generating device, via an earphone. For best listening pleasure, a user needs an earphone that turns audio signals into high fidelity sound.

Human voices and various musical sounds are various signals having complicated waveforms. The frequency of sound audible to the human ear is generally in the range from 20 Hz to 20 KHz. The frequency range of speech is mainly from 150 Hz to 4 KHz, and the frequency range of musical sound is mainly from 40 Hz to 18 KHz. The energy of the human voice is mostly distributed in the frequency range of 200 Hz-35 KHz. Therefore, in order to correctly play such a wide variety of signals and obtain high quality timbre, an earphone is required to have a wide frequency response characteristic, adequate sound pressure levels, and a large dynamic range. Further, an earphone is also desired to attain a perfect frequency-efficiency characteristic and a perfect frequency-phase delay characteristic. If this is achieved, the output of the earphone maintains high power efficiency and low phase leads or delays as compared to the input of the earphone, accordingly, a listener will hear sounds in high quality timbre. In the following description, phase leads and phase delays are collectively referred to simply as phase delays.

A conventional earphone typically has a frequency-efficiency characteristic and a frequency-phase delay characteristic. These characteristics typically cause much deviation of the output of the earphone from the input of the earphone. That is, the real output is far from an ideal output, and results in poor timbre.

To solve such problem, what is needed is a sound output system and method which have compensation characteristic.

### SUMMARY

A sound output system is provided. The sound output system includes a sound output apparatus and an audio signal generating device. The sound output apparatus includes a memory for storing compensation parameter a Universal Serial Bus (USB) controller for communicating with the audio signal generating device via a USB interface; and an analog interface. The audio signal generating device includes a USB controller for communicating with the sound output apparatus via a USB interface, detecting whether the sound output apparatus is connected thereto, transmitting a signal for reading the compensation parameters for the sound output apparatus from the memory to the sound output apparatus if the sound output apparatus is connected thereto; a compensation unit for regulating audio signals output according to the compensation parameters; a digital/analog (D/A) converter for converting the regulated audio signals into analog audio signals; and an amplifier for amplifying the analog audio signals, and transmitting the amplified analog audio signals via an analog interface to the analog interface of the sound output apparatus.

A sound output method is also provided. The sound output method includes the steps of: (a) providing a sound output apparatus and an audio signal generating device for outputting audio signals, the sound output apparatus providing a Universal Serial Bus (USB) interface and an analog interface; (b) detecting whether the sound output apparatus is connected to the audio signal generating device; (c) transmitting compensation parameters via the USB interface from the sound output apparatus to the audio signal generating device if the sound output apparatus is connected to the audio signal generating device; (d) regulating the audio signals output according to the compensation parameters; (e) converting the regulated audio signals into analog audio signals, and transmitting the analog audio signals to the analog interface of the sound output apparatus; and (f) outputting sounds corresponding to the analog audio signals.

In additional, sound output apparatus is also provided. The sound output apparatus includes a memory for storing compensation parameters; a Universal Serial Bus (USB) interface for connecting an external audio signal generating device thereto; a USB controller for reading the compensation parameters from the memory to the external audio signal generating device when external the audio signal generating device is connected thereto; and an analog interface for receiving regulated audio signals from the external audio signal generating device according to the compensation parameters.

Furthermore, a sound output system is also provided. The sound output system includes a sound output apparatus and an audio signal generating device for outputting audio signals. The sound output apparatus includes a memory for storing compensation parameters; and a Universal Serial Bus (USB) controller for communicating with the audio signal generating device. The audio signal generating device includes a USB controller for communicating with the sound output apparatus, detecting whether the sound output apparatus is connected thereto, transmitting a signal for reading the compensation parameters stored in the sound output apparatus and transmitting the compensation parameters from the memory to the sound output apparatus if the sound output apparatus is connected to the USB controller; and a compensation unit for regulating the audio signals according to the compensation parameters.

Other advantages and novel features will become more apparent from the following detailed description when taken in conjunction with the accompanying drawings, in which:

### BRIEF DESCRIPTION OF DRAWINGS

FIG. 1 is a block diagram of a sound output system in accordance with a preferred embodiment of the present invention; and

FIG. 2 is a flowchart of a preferred sound output method by implementing the system in FIG. 1.

### DETAILED DESCRIPTION OF THE PREFERRED EMBODIMENT

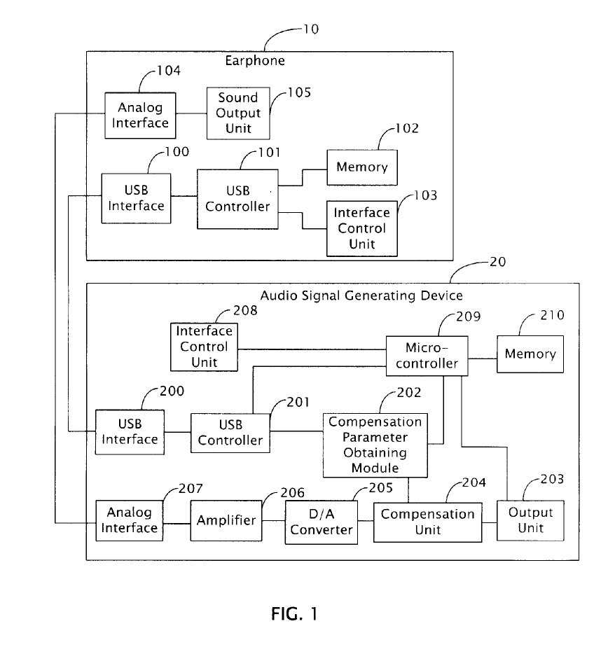

FIG. 1 is a block diagram of a sound output system in accordance with a preferred embodiment of the present invention. The sound output system mainly includes an earphone 10 and an audio signal generating device 20. According to the preferred embodiment, the earphone 10 can be substituted by any other sound output apparatus that can transform audio signals into sounds, such as a speaker or the like. The earphone 10 is used to transform audio signals from a predetermined frequency range into sounds having corresponding sound pressure levels. The audio signal generating device 20 may be an MP3 player, a CD player, a computer, and so on. In the preferred embodiment, the audio signal generating device 20 takes MP3 player as an example.

The earphone 10 includes a Universal Serial Bus (USB) controller 101, a memory 102, an analog interface 104, and a sound output unit 105. The audio signal generating device 20 includes a USB controller 201, a compensation parameter obtaining module 202, an output unit 203, a compensation unit 204, a digital/analog (D/A) 205, an amplifier 206, an analog interface 207, an interface control unit 208, a micro-controller 209, and a memory 210.

The earphone 10 has real characteristics per se, including but not limited to a real frequency-efficiency characteristic and a real frequency-phase delay characteristic. The real characteristics cause real outputs of the earphone 10 to deviate from ideal outputs of the earphone 10, thereby resulting in a distortion of the outputs. In order to prevent the distortion, compensation parameters thereupon are introduced and provided in the memory 102. The compensation parameters include a compensation frequency-efficiency parameter and a compensation frequency-phase delay parameter. Each of the compensation parameters is derived from a testing system (not shown) according to a corresponding real characteristic of the earphone 10, and is adapted to minimize or even eliminate deviations between uncompensated outputs and ideal outputs of the earphone 10. Building principles of the compensation parameters refer to U.S. patent application Ser. No. 11/173130. In addition, the memory 102 is further connected to the USB controller 101.

The earphone 10 and the audio signal generating device 20 respectively have a Universal Serial Bus (USB) interface 100 and a USB interface 200 for connecting each other. The USB interface 100 is connected with the USB controller 101. The USB interface 200 is connected with the USB controller 201.

The USB controller 201 detects whether the USB interface 200 is connected to an earphone 10. If so, the USB controller 201 transmits a detection signal to the earphone 10. The USB controller 101 receives the detection signal via the USB interface 100, reads the compensation parameters for the earphone 10 from the memory 102 referencing the detection signal, and transmits the compensation parameters to the audio signal generating device 20.

The compensation parameter obtaining module 202 is connected with the USB controller 201, the compensation unit 204, and the micro-controller 209, and is for receiving the compensation parameters via the USB interface 200. The memory 210 is connected to the micro-controller 209, and is for storing audio files and video files. If the interface control unit 208 receives a play operation from a user, the micro-controller 209 controls the output unit 203 to read audio files from the memory 210 and output corresponding audio signals, the compensation unit 204 regulates the audio signals according to the compensation parameters, in order to approach or even attain the ideal output of the earphone 10, and supplies the regulated audio signals to the D/A converter 205 so as to convert the regulated audio signals into analog audio signals. The amplifier 206 amplifies the analog audio signals, and transmits the amplified analog audio signals via the analog interface 207 to the earphone 10. The earphone 10 receives the amplified analog audio signals via the analog interface 104. The sound output unit 105 outputs sounds corresponding to the amplified analog audio signals.

The earphone 10 further includes an interface control unit 103. The interface control unit 103 is connected with the USB controller 101, and is for receiving operational inputs that include adjusting volume and making a song selection. The interface control unit 208 is further used for receiving another operational input for adjusting volume.

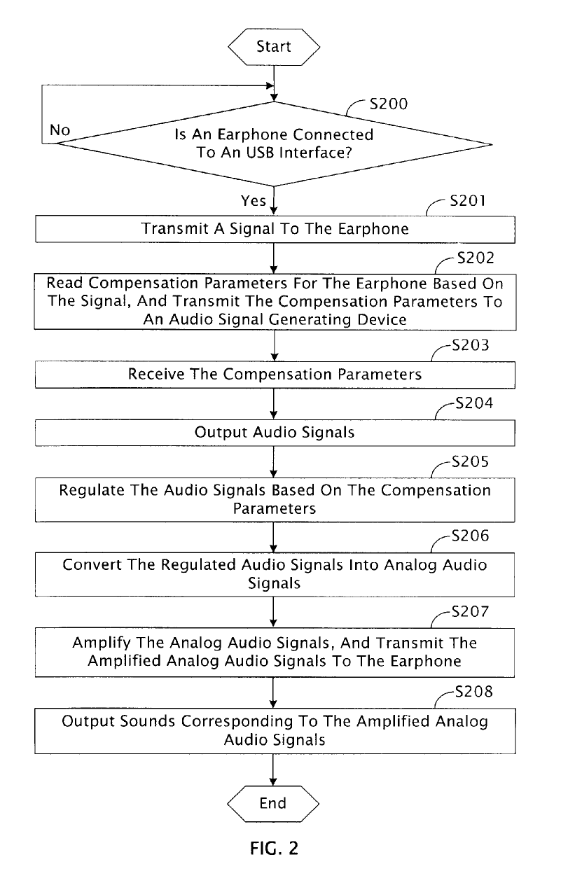

FIG. 2 is a flowchart of a preferred sound output method by implementing the system of FIG. 1. In step S200, the USB controller 201 detects whether an earphone 10 is connected to the USB interface 200. If the earphone 10 is not connected to the USB interface 200, the procedure repeats step S200. Otherwise, in step S201, the USB controller 201 transmits a detection signal to the earphone 10. In step S202, the USB controller 101 reads the compensation parameters for the earphone 10 from the memory 102 based on the detection signal, and transmits the compensation parameters to the audio signal generating device 20 via the USB interface 100. In step S203, the compensation parameter obtaining module 202 receives the compensation parameters via the USB interface 200.

In step S204, the output unit 203 outputs audio signals. In step S205, the compensation unit 204 regulates the audio signals according to the compensation parameters, in order to approach or even attain the ideal output of the earphone 10. In step S206, the D/A converter 205 converts the regulated audio signals into analog audio signals. In step S207, the amplifier 206 amplifies the analog audio signals, and transmits the amplified analog audio signals to the earphone 10 via the analog interface 207. In step S208, the earphone 10 receives the amplified analog audio signals via the analog interface 104, and outputs sounds corresponding to the amplified analog audio signals via the sound output unit 105.

Although the present invention had been specifically described on the basis of the preferred embodiment including the preferred method, the invention is not to be construed as being limited thereto. Various changes or modifications may be made to the embodiment including the method without departing from the scope and spirit of the invention.

What is claimed is:

1. A sound output system comprising a sound output apparatus and an audio signal generating device for outputting audio signals, wherein:
the sound output apparatus comprises:
a memory for storing compensation parameters;
a Universal Serial Bus (USB) controller for communicating with the audio signal generating device via a USB interface; and
an analog interface; and
the audio signal generating device comprises:
a USB controller for communicating with the sound output apparatus via a USB interface, detecting whether the sound output apparatus is connected thereto, transmitting a signal for reading the compensation parameters for the sound output apparatus from the memory to the sound output apparatus if the sound output apparatus is connected thereto;
a compensation unit for regulating the audio signals according to the compensation parameters;
a digital/analog (D/A) converter for converting the regulated audio signals into analog audio signals; and
an amplifier for amplifying the analog audio signals, and transmitting the amplified analog audio signals via an analog interface to the analog interface of the sound output apparatus.

2. The sound output system according to claim 1, wherein the compensation parameters are built according to real characteristics of the sound output apparatus.

3. The sound output system according to claim 2, wherein the compensation parameters comprise a compensation frequency efficiency parameter for minimizing or even eliminating deviations of outputs of the sound output apparatus due to the real characteristics of the sound output apparatus.

4. The sound output system according to claim 2, wherein the compensation parameters comprise a compensation frequency-phase delay parameter for minimizing or even eliminating deviations of outputs of the sound output apparatus due to the real characteristics of the sound output apparatus.

5. The sound output system according to claim 1, wherein the USB controller of the sound output apparatus is connected to the memory, for reading compensation parameters stored in the memory, and transmitting the compensation parameters to the audio signal generating device.

6. The sound output system according to claim 1 wherein the sound output apparatus is an earphone.

7. A sound output method providing a sound output apparatus and an audio signal generating device for outputting audio signals, the method comprising the steps of:
providing a Universal Serial Bus (USB) interface and an analog interface in the sound output apparatus;
detecting whether the sound output apparatus is connected to the audio signal generating device;
transmitting compensation parameters via the USB interface from the sound output apparatus to the audio signal generating device if the sound output apparatus is connected to the audio signal generating device;
regulating the audio signals according to the compensation parameters;
converting the regulated audio signals into analog audio signals, and transmitting the analog audio signals to the analog interface of the sound output apparatus; and
outputting sounds corresponding to the analog audio signals.

8. The sound output method according to claim 7, wherein the compensation parameters comprise a compensation frequency-efficiency parameter for minimizing or even eliminating deviations of outputs of the sound output apparatus due to real characteristics of the sound output apparatus.

9. The sound output method according to claim 7, wherein the compensation parameters comprise a compensation frequency-phase delay parameter for minimizing or even eliminating deviations of outputs of the sound output apparatus due to real characteristics of the sound output apparatus.

10. The sound output method according to claim 7, wherein the sound output apparatus is an earphone.

11. A sound output apparatus comprising:
a memory for storing compensation parameters;
a Universal Serial Bus (USB) interface for connecting an external audio signal generating device thereto;
a USB controller for reading the compensation parameters from the memory to the external audio signal generating device when the external audio signal generating device is connected thereto; and
an analog interface for receiving regulated audio signals from external the audio signal generating device according to the compensation parameters.

12. The sound output apparatus 11, wherein the compensation parameters comprise a compensation frequency-efficiency parameter for minimizing or even eliminating deviations of outputs of the sound output apparatus due to real characteristics of the sound output apparatus.

13. The sound output apparatus 11, wherein the compensation parameters comprise a compensation frequency-phase delay parameter for minimizing or even eliminating deviations of outputs of the sound output apparatus due to real characteristics of the sound output apparatus.

14. The sound output apparatus 11, wherein the sound output apparatus is an earphone.

15. A sound output system comprising a sound output apparatus and an audio signal generating device for outputting audio signals, wherein:
the sound output apparatus comprises:
a memory for storing compensation parameters;
a Universal Serial Bus (USB) controller for communicating with the audio signal generating device;
the audio signal generating device comprises:
a USB controller for communicating with the sound output apparatus, detecting whether the sound output apparatus is connected thereto, transmitting a signal for reading the compensation parameters stored in the sound output apparatus and transmitting the compensation parameters from the memory to the sound output apparatus if the sound output apparatus is connected to the USB controller; and
a compensation unit for regulating the audio signals according to the compensation parameters.
